(19) United States
(12) Patent Application Publication
(10) Pub. No.: US 2011/0268847 A1
(43) Pub. Date: Nov. 3, 2011

(54) LOW JUICE CONCENTRATE COMPOSITION FOR PROVIDING EDIBLE CALCIUM-FORTIFIED PRODUCTS USING STABILIZED EMULSIFIED CLOUD

(75) Inventors: David K. Yang, Manhatten, KS (US); Juvenal Higiro, Manhatten, KS (US)

(73) Assignee: The Coca-Cola Company, Atlanta, GA (US)

(21) Appl. No.: 12/770,979

(22) Filed: Apr. 30, 2010

(51) Int. Cl. A23L 2/62; A23L 2/02

(52) U.S. Cl. 426/74; 426/601; 426/599; 426/330.5

(57) ABSTRACT

A calcium-fortified “low juice” concentrate having calcium citrate malate in an amount providing a level of solubilized calcium of at least about 0.2% by weight of the concentrate, and a level of total acids sufficient to impart a pH of about 4.2 or less to the concentrate; an opacifying amount of an emulsified cloud containing an oil phase and a cloud emulsifier in a weight ratio of cloud emulsifier to oil phase of at least about 0.1:1; and an emulsified cloud stabilizer component to stabilize the emulsified cloud component and containing pectin in an amount of at least about 0.01% by weight of the concentrate; and propylene glycol alginate in an amount of at least about 0.03% by weight of the concentrate.

### FIELD OF THE INVENTION

The present invention broadly relates to “low juice” concentrate compositions for providing edible calcium-fortified products comprising highly solubilized calcium, an emulsified cloud component comprising an oil phase and a cloud emulsifier, and an emulsified cloud stabilizer component comprising pectin and propylene glycol alginate to stabilize the emulsified cloud component. The present invention further generally relates to a method for preparing such concentrate compositions using the stabilized emulsified cloud component.

### BACKGROUND

Acidic juices and fruit flavor based beverages may be fortified with micronutrients or functional ingredients, for example, calcium, in order to meet the growing consumer demand for healthy beverage alternatives. These juice/fruit flavor-based beverages may be provided as single-strength, ready-to-drink products. Alternatively, liquid concentrates or syrups may be prepared which may be reconstituted with water or its equivalent (e.g., fruit juices, etc.) to provide single-strength products having equivalent functionality and nutrition content as these ready-to-drink products.

Calcium fortification of beverages may be difficult because of the poor solubility of calcium salts in solution. This poor solubility may not only cause precipitation in these fortified products but also may cause a chalky taste and undesirable aftertaste problems. For example, highly soluble calcium sources, for example, calcium citrate malate (CCM) is known to be highly soluble for juice beverage applications and may be more bioavailable than other calcium fortification source to benefit bone health. See, for example, U.S. Pat. No. 4,722,847 (Heckert), issued Feb. 2, 1988, and U.S. Pat. No. 4,737,375 (Nakel et al.), issued Apr. 12, 1988.

But at significant calcium levels (e.g., at least about 0.2% by weight calcium) in concentrates used to prepare such calcium-fortified beverage products, total acidity may need to be increased in order to maintain calcium solubility and prevent the precipitation of insoluble calcium salts. This higher acidity, while improving solubility and stability, may also be detrimental to the palatability and taste quality of the product prepared from such concentrates by imparting, for example, unacceptable sourness and unpleasant aftertastes, as well as potential destabilizing effects on other added beverage components. Accordingly, there is still a need for concentrates that may be used to provide higher acidity food (e.g., beverage) products that allow for significant fortification with highly solubilized calcium, that have improved taste impressions and overall taste acceptance, as well as acceptable storage stability against precipitation or phase separation of components present in these products.

### SUMMARY

According to a first broad aspect of the present invention, there is provided a composition comprising a calcium-fortified concentrate, the concentrate comprising:
calcium citrate malate in an amount providing a level of solubilized calcium of at least about 0.2% by weight of the concentrate, and a level of total acids sufficient to impart a pH of about 4.2 or less to the concentrate;
an opacifying amount of an emulsified cloud component comprising:
   an oil phase; and
   a cloud emulsifier in a weight ratio of cloud emulsifier to oil phase of at least about 0.1:1; and
an emulsified cloud stabilizer component to stabilize emulsified cloud component, the emulsified cloud stabilizer component comprising:
   pectin in an amount of at least about 0.01% by weight of the concentrate; and
   propylene glycol alginate in an amount of at least about 0.03% by weight of the concentrate;
wherein the concentrate comprises from about 10 to about 80% by weight solids, and from about 2 to about 15% juice on a single-strength basis.

According to a second broad aspect of the invention, there is provided a method comprising the following steps:
(a) mixing an emulsified cloud component and an emulsified cloud stabilizer component under high shear conditions to provide a stabilized emulsified cloud component; and
(b) combining the stabilized emulsified cloud component with other concentrate ingredients comprising calcium citrate malate to provide an edible calcium-fortified concentrate, wherein the calcium citrate malate is in an amount sufficient to provide a level of solubilized calcium of at least about 0.2% by weight of the concentrate, and a level of total acids sufficient to impart a pH of about 4.2 or less to the concentrate, wherein the concentrate comprises from about 10 to about 80% by weight solids, and from about 5 to about 15% juice on a single-strength basis, wherein the emulsified cloud component is in an opacifying amount and comprises:
   an oil phase; and
   a cloud emulsifier in a weight ratio of cloud emulsifier to oil phase of at least about 0.1:1;
wherein the emulsified cloud stabilizer component comprises:
   pectin in an amount of at least about 0.01% by weight of the concentrate; and
   propylene glycol alginate in an amount of at least about 0.03% by weight of the concentrate.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “edible” refers to any product, material, ingredient, additive, etc., which may be ingested and which is safe for humans to eat.

For the purposes of the present invention, the term “edible product” refers to any product classified as a “food” by the U.S. Food and Drug Administration, including foods, beverages, etc., as well as any product classified as a “supplement” by the U.S. Food and Drug Administration, including weight loss products, meal replacement products, supplement products (e.g., vitamin and/or mineral supplement products), etc. Food products (e.g., beverages), as well as supplement products, may include any food or supplement product that may be directly drunk or ingested or any food (e.g., beverage) concentrate, as well as supplement concentrates which may be further mixed with other ingredients (e.g., water, juice, etc.) to form a food or supplement product that may be drunk or ingested, or which may provide, in undiluted form, a ready-to-drink liquid concentrate supplement product (e.g., a concentrated energy drink, etc.). For example, a food (e.g., beverage) concentrate may be mixed with a liquid to form a drink, added (e.g., in liquid form) to food ingredients, such as flour and baked to form a bakery product, etc. Embodiments of a food or supplement product prepared from or with these edible concentrates may be in various forms such as, for example, a liquid, a frozen or semi-frozen liquid, a nutritional supplement, a nutritional bar, a nutritional beverage, a pudding, a sauce, a gravy, a soup, a broth, a soup consommé, a sherbet, sorbet, a gelato, a slush, a smoothie, a yogurt, a custard, a beverage in the form of, for example, a non-carbonated drink, a carbonated beverage (e.g., soda), a nutritional beverage such as a power aid beverage, an energy drink, etc., a juice-containing drink product, a tea, a milkshake, etc.

For the purposes of the present invention, the term “food additive” refers to the common meaning of the term “food additive” and includes any product classified as a “food additive” by the U.S. Food and Drug Administration. Food additives (e.g., beverage additives) may include non-caloric sweeteners, colorants, flavorants, juices, edible acids, mineral or vitamin fortifying agents, fats or oils, emulsifiers, fat substitutes such as olestra, etc.

For the purposes of the present invention the term “serving” refers to the appropriate serving size for a food or supplement product, for example, a nutritional beverage, nutritional composition, weight loss product, meal substitute, etc., as established by the United States Food and Drug Administration (FDA) and the Nutrition and Labeling Act (NLEA), as set forth in 21 C.F.R §101, or any subsequent version of the FDA regulatory rules that may correspond to 21 C.F.R §101. The present invention also adopts the NLEA's definition of a serving size as being the amount of food customarily eaten at one time. When the food or supplement product of the present invention comprises a nutritional beverage or liquid meal substitute, a typical serving size may be from about 100 to about 530 mL. A single serving of the food or supplement product may be packaged in various types of, for example, “single serving” packages/containers that are known in the art.

For the purposes of the present invention, the terms “solids basis” and “dry basis” refer interchangeably to the weight percentage of each of the respective solid materials (e.g., calcium citrate malate, oil phase, emulsifiers, pectin, propylene glycol alginate, vitamins, trace mineral(s), etc.) present in the absence of any liquids (e.g., water).

For the purposes of the present invention, the terms “container” and “package” are used interchangeably and refer to a package or container that contains edible products and edible concentrates of the present invention. The specific type of package or container, either of a single-serving size or any other size, used as a container for the edible product or edible concentrate may depend on such factors as whether the edible product or edible concentrate is a liquid, semi-frozen, or frozen (i.e., solid), etc., whether the edible product or edible concentrate includes perishable components, components that need to be refrigerated, etc.

For the purposes of the present invention, the term “liquid food product” or “liquid supplement product” refers to any food or supplement product that is liquid at room temperature (e.g., at from about 20° to about 25° C. Liquid foods or supplements may be in the form of solutions, colloidal suspensions, thixotropic mixtures, etc., for example, aqueous foods or supplements (i.e., those comprising water or a source of water as a suspending agent, solubilizing agent, carrier, etc., with or without other suspending agents, solubilizing agents, carriers, etc., such, as for example, alcohol, etc.). Liquid foods or supplements may include: bottled water, non-carbonated drinks, carbonated beverages (e.g., soda), energy drinks, fruit drinks, tea, shakes, sherbet, sorbet, puddings, etc.

For the purposes of the present invention, the terms “ready-to-eat” (R-T-E) or “ready-to-drink” (R-T-D) refer to a food product, a beverage product, or a supplement product, that is essentially ready for human consumption with minimal or no additional preparation such as cooking, heating, mixing with other ingredients, etc.

For the purposes of the present invention, the term “edible acid” refers to any acid that is edible. Suitable edible acids may include citric acid, malic acid, fumaric acid, maleic acid, tartaric acid, succinic acid, malonic acid, glutaric acid, adipic acid, aspartic acid, glutaconic acid, glutamic acid, phosphoric, etc.

For the purposes of the present invention, the term “acidulant” refers to one or more edible acids used in foods and/or beverages to impart a tart, sour, etc., taste to the food or beverage product, to maintain a lower pH in the concentrate or product, to function as preservative in the concentrate or product, etc.

For the purposes of the present invention, the term “solubilized calcium” refers to any source of calcium which may be solubilized in water or other aqueous environment (e.g., fruit juice) and which may provide bioavailable calcium in the gut. The sources of solubilized calcium source may be any water-soluble organic or inorganic salt, or a mixture of organic or inorganic salts. Sources of solubilized calcium may include calcium hydroxide, calcium chloride, calcium citrate, calcium malate, calcium citrate malate, calcium carbonate, calcium phosphate (e.g., monobasic calcium phosphate, dibasic calcium phosphate, tricalcium phosphate, etc.), calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, calcium tartrate, etc., or mixtures thereof.

For the purposes of the present invention, the term “calcium citrate malate” refers to an at least meta-stable complex of calcium with citrate and malate anions. Besides increasing calcium solubilization, another benefit of calcium citrate malate is that this complex does not interfere, or at least does not interfere in a significant way with the bioavailability or absorption of other minerals, including trace minerals.

For the purposes of the present invention, the term “bioavailable” refers to a calcium source which is available for absorption by the gut.

For the purposes of the present invention, the term “high shear mixing conditions” refers to mixing conditions, for example, under a combination of impeller velocity and tank turnover (determined by batch size and solution viscosity), which may form stabilized particles having a mean particle size of about 0.3 microns or less (e.g., from about 0.1 to about 0.3 microns), and may include homogenization. High shear mixing conditions may be created using numerous commercial mixing systems, for example, Likwifier, Liquiverter, etc. These mixing conditions may be exemplified by, but are not limited to, a pitch blade turbine operated with an impeller velocity of at least about 1000 ft/min. (900 rpm, 2.54 inch impeller) for a 650 ml batch in a 1.25 liter vessel. Other high shear mixers, mixer blade configurations, high shear roto-stator devices, etc., with a shear rate of least about 45,000 sec⁻¹ may also be employed. High shear mixing may be used to efficiently hydrate the pectin and propylene glycol alginate (PGA) in forming the stabilized emulsified cloud system prior to combining, mixing, blending, etc., the stabilized emulsified cloud system with other edible concentrate components.

For the purposes of the present invention, the term “vitamin D” refers to compounds, compositions, etc., which may include vitamin D₃, vitamin D₂, 25(OH)D₃, 25(OH)D₂, 1α,25(OH)₂ D₃, 1α,25(OH)₂ D₂, etc., as well as mixtures thereof.

For the purposes of the present invention, the term “trace minerals” refers to those minerals which are important for bone growth and age-related bone health. These trace minerals may include one or more of iron, zinc, magnesium, manganese, copper, potassium, etc., including mixtures of these trace minerals.

For the purposes of the present invention, the term “RDA” refers to the Recommended Dietary Allowances for various vitamins and minerals, including calcium, vitamin D and other trace minerals. These Recommended Dietary Allowances (RDAs) are a set of estimated nutrient allowances established by the National Academy of Sciences, which are updated periodically to reflect current scientific knowledge.

For the purposes of the present invention, the term “high acid environment” refers to a pH of about 4.2 or less, for example, a pH of from about 3.0 to about 3.8. For example, for a single-strength product, such a high acid environment may comprise total acids of at least about 0.7% by weight of the product, e.g., in the range of from about 0.7% to about 2.6% by weight of the product. For embodiments of an edible concentrate of the present invention, such a high acid environment may comprise total acids of at least about 1.5% by weight of the concentrate, e.g., in the range of from about 1.5 to about 13% by weight of the concentrate.

For the purposes of the present invention, the term “emulsified cloud” refers to any opaque emulsion which may be used to provide opacity (“cloud”), texture, and optionally flavor in an edible product, and which comprises, at minimum, an oil phase and a cloud emulsifier. Emulsified clouds may also be referred to interchangeably as “cloud emulsions” or “emulsion clouds” and include “beverage cloud emulsions” (i.e., for use in beverage products) and “food cloud emulsions” (i.e., for use in food products). Emulsified clouds which additionally comprise flavorants may be referred to as “flavor emulsions.”

For the purposes of the present invention, the term “opacifying amount” refers to an amount of the emulsified cloud component sufficient to provide a visible and recognizable degree of opacity to the edible product prepared from the edible concentrate. The particular amount of the emulsified cloud component which may provide an opacifying benefit may depend on a variety of factors, including the opacity and textural (e.g., mouthfeel) benefits which the emulsified cloud component is replacing for the particular juice component present in the edible concentrate which is being reduced to provide a lower juice level.

For the purposes of the present invention, the term “oil phase” refers to any unweighted digestible or nondigestible oil component from any animal or vegetable source which may provide opacity or “cloud” an emulsified cloud, including, for example, terpene hydrocarbons, vegetable oils (e.g., high oleic sunflower oil, canola oil, cottonseed oil, other vegetable oils stable against lipid oxidation, etc.), flavor oils, brominated vegetable oil (BVO), nondigestible polyol polyesters, such as those described in U.S. Pat. No. 3,600,186 (Mattson et al.), issued August 1971 and U.S. Pat. No. 4,005,195 (Jandacek et al.), issued January 1977, the entire contents and disclosures of which are herein incorporate by reference, or mixtures thereof.

For the purposes of the present invention, the term “cloud emulsifier” refers to any edible food grade hydrophilic colloidal (hydrocolloid) emulsifier which may be used to stabilize the oil phase of an emulsified cloud in an aqueous edible concentrate. Suitable cloud emulsifiers may include, for example, hydrophilic colloidal stabilizers such as gum arabic, locust bean, etc.; anionic polymers derived from cellulose (e.g., carboxymethylcellulose), which are water soluble and may tolerate lower pH's (i.e., are acid-stable), etc.; modified starches, etc., or mixtures thereof.

For the purposes of the present invention, the term “modified starch emulsifier” refers to starch (or starch granules) which is treated to partially degrade the starch, or to otherwise modify the starch molecule. Suitable modified starch emulsifiers may include acid-treated starch, alkaline modified starch, bleached starch, oxidized starch, enzyme-treated starch, acetylated starch, acetylated oxidized starch, resistant starch (i.e., non-digestible starch), etc. Modified starch emulsifiers may include starches which are modified so that they contain hydrophobic as well as hydrophilic groups, such as those described in U.S. Pat. No. 2,661,349 (Caldwell et al.), issued Dec. 1, 1953, the entire disclosure and contents of which is herein incorporated by reference, as well as starch alkenylsuccinates, including octenyl succinate modified starches such as those described in U.S. Pat. No. 3,455,838 to (Marotta et al.), issued Jul. 15, 1969 and U.S. Pat. No. 4,460,617 (Barandt et al.), issued Jul. 17, 1984, the entire contents and disclosures of which are herein incorporated by reference, etc.

For the purposes of the present invention, the term “stabilized emulsified cloud component” refers to an emulsified cloud system wherein the emulsified cloud component has been stabilized with an emulsified cloud stabilizer component in amounts sufficient to stabilize the emulsified cloud system. The stabilized emulsified cloud component may be formed by mixing the emulsified cloud component and the emulsified cloud stabilizer component under high shear mixing conditions, such as by using homogenization.

For the purposes of the present invention, the term “emulsified cloud stabilizer component” refers to the stabilizer component which comprises, at minimum, a combination of pectin and propylene glycol alginate that is used to stabilize the emulsified cloud component.

For the purposes of the present invention, the term “pectin” refers to a hydrocolloidal polysaccharide normally comprising a linear backbone of α-(1-4)-linked D-galacturonic acid units which have carboxyl groups which may be partially methoxylated (i.e., methyl esters), partially neutralized (e.g., salts such as sodium, potassium, calcium, ammonium, etc., salts), and/or partially free (i.e., unmethoxlyated and unneutralized), as well as regions of (1-2)-linked L-rhamnose units from which side chains of neutral sugars such as D-galactose, L-arabinose, D-xylose, etc., may branch off, and which may have molecular weights of, for example, from about 100,000 to about 150,000 M.W. Suitable pectins may include acidic pectins such as high methoxy pectins having a degree of methoxylation of greater than about 50% (i.e., greater than about 50% of the carboxyl groups are methyl esters), etc., for example, commercially available high methoxy pectins such as Genu® Pectin YM-100H from Copenhagen Pectin A/S, a division of Hercules Incorporated, DK-4623 Lille Skensved, Denmark, which has a degree of esterification (e.g., methoxylation) of about 72%.

For the purposes of the present invention, the term “propylene glycol alginate (PGA)” refers to propylene glycol esters of alginic acid, wherein at least some of the carboxyl groups of the alginic acid are esterified with propylene glycol units (e.g., by using propylene oxide), and wherein the remaining carboxyl groups may be partially neutralized (i.e., form salts such as sodium, potassium, calcium, ammonium, etc., salts), and/or partially free (i.e., unesterified and unneutralized), and which may have a molecular weight of, for example, from about 10,000 to about 600,000 M.W. Suitable propylene glycol alginates may include commercially available propylene glycol alginates such as Coyote Brand PGA-M available from Gum Technology, 509 W. Wetmore Road, Tucson, Ariz., USA, which has a degree of esterification of from about 45 to about 50%.

For the purposes of the present invention, the terms “single-strength food product” and “single-strength supplement product” refer, respectively, to a food product or supplement product which is in a single-strength, ready-to-serve, ingestible form. Such single-strength products may be prepared from embodiments of edible concentrates of the present invention.

For the purposes of the present invention, the term “edible concentrate” refers to an edible product (e.g., a food concentrate, a beverage concentrate, a supplement concentrate, etc.) which, when reconstituted (e.g., diluted) with the appropriate amount of water, other liquids (e.g., fruit juices, etc.) which are equivalent sources of water, etc., may form a single-strength food product or single-strength supplement product, or which, in undiluted form, provides a ready-to-drink liquid concentrate supplement product (e.g., a concentrated energy drink, etc.). Edible concentrates may be formulated, for example, to provide single-strength food products or single-strength supplement products when reconstituted (e.g., diluted) with from about 1 to about 5 parts, such as from about 3 to about 5 parts (e.g., from about 4 to about 5 parts) by volume water or its equivalent (e.g., fruit juices, etc.). For example, a “1+1 concentrate” refers to an edible concentrate which provides a single-strength edible product when reconstituted with 1 part by volume water (or its equivalent), while a “4+1 concentrate” refers to an edible concentrate which provides a single-strength edible product when reconstituted with 4 parts by volume water (or its equivalent). Edible concentrates may also be formulated to provide undiluted, concentrated liquid supplement products.

For the purposes of the present invention, the term “low juice” refers to edible products and concentrates which comprise from about 2 to about about 15% juice (e.g., fruit juice) on a single-strength basis, for example, from about 2 to about 5% juice.

For the purposes of the present invention, the term “fruit juice-based beverage” refers to a fruit juice product which is in a single-strength, ready-to-serve, drinkable form, and which comprises fruit juice in an amount at least about 2% on a single-strength basis. Fruit juice beverages may comprise up to about 15% fruit juice (single-strength basis) by weight of the beverage, for example, from about 2 to about 5% fruit juice.

For the purposes of the present invention, the term “fruit juice concentrate” refers to a beverage concentrate which, when diluted with the appropriate amount of water, forms drinkable fruit juice-based beverages. Fruit juice concentrates may be formulated, for example, to provide drinkable beverages when reconstituted (e.g., diluted) with from about 1 to about 5 parts, such as with from about 3 to about 5 parts, by volume water or its equivalent.

For the purposes of the present invention, the term “concentrated fruit juice” refers to fruit juice from which a portion of the water has been removed.

For the purposes of the present invention, the term “fruit juice materials” refers to fruit juice, plus other fruit juice materials such as, for example, fruit juice aroma and flavor volatiles, peel oils, pulp or pomace, etc.

For the purposes of the present invention, the term “fruit juice” refers to citrus juices, noncitrus juices such as apple juice, grape juice, pear juice, cherry juice, berry juice, pineapple juice, peach juice, apricot juice, plum juice, prune juice, etc., and mixtures of these juices.

For the purposes of the present invention, the term “citrus juice” refers to fruit juices selected from orange juice, lemon juice, lime juice, grapefruit juice, tangerine juice etc., and mixtures of these juices.

For the purposes of the present invention, the term “shelf-stable” refers to embodiments of an edible product or an edible concentrate which do not require refrigeration at temperatures of about 4° C. or lower, and which, in some embodiments, may not require storage at temperatures of about 21° C. or lower.

For the purposes of the present invention, the term “relative molar ratio” refers to the relative ratio of the molar concentrations of two or more ingredients, components, etc., present in a solution. For example, a three-component relative molar ratio of particular interest to embodiments of the present invention involves the relative molar ratio of calcium to citric acid to malic acid (also represented herein as “calcium:citric acid:malic acid”).

For the purposes of the present invention, the term “Degrees Brix (“° Bx)” refers to a measurement of the dissolved sugar-to-water mass ratio of a liquid. For example, a 25° Bx solution comprises 25 g. of dissolved sugar per 100 g. of solution.

### Description

Embodiments of the present invention relate to calcium-containing “low juice” edible concentrates (e.g., beverage concentrates) which may comprise from about 10 to about 80% by weight solids (e.g., from about 30 to about 70% by weight solids). These edible concentrates are useful, for example, in being reconstituted with water (or its equivalent) to provide single-strength high acid, calcium-fortified “low juice” edible products, such as calcium-fortified “low juice” beverage products, containing high levels of solubilized and bio-available calcium. Embodiments of these edible concentrates may provide excellent stability under high temperature processing and during storage, without or without the need for homogenization during the preparation of the concentrate. Embodiments of these shelf-stable, edible concentrates, when diluted with water (or its equivalent) to provide single-strength edible products, may offer calcium-fortified high acid food and supplement products (e.g., beverage products) having excellent taste and palatability profiles.

Providing “low juice” edible concentrates which comprise calcium levels of at least about 0.2% by weight (e.g., from about 0.2 to about 0.65% by weight, such as from about 0.35 to about 0.65% by weight) of the concentrate which may be made shelf stable, with no phase separation and little or no sedimentation, and which may be reconstituted with water or its equivalent to provide calcium-fortified food and supplement products which taste good may be an especially difficult challenge, including “low juice” (i.e., from about 2 to about 15% juice on a single-strength basis) products. Edible concentrates (such as beverage concentrates) which comprise very minimal amounts of water (i.e., about 20% or less by weight of the concentrate) magnify the problem of having higher levels of solubilized calcium. Higher levels of acids may somewhat overcome the solubility limitations of calcium, but the presence of other solids (e.g., emulsified clouds) in such high acid products, coupled with higher temperature processing may add greater chemical complexities which may render the edible concentrate (e.g., beverage concentrate) unstable and the reconstituted edible product (e.g., beverage product) possibly unpalatable.

In highly calcium fortified, higher acid “low juice” concentrates, an emulsified cloud may be required to provide the opacity, as well as the textural (e.g., mouthfeel) properties, normally provided by including higher amounts of juice (i.e., above about 15%. For example, these highly calcium fortified, higher acid “low juice” concentrates may be used in fountain syrup applications where the highly calcium fortified, higher acid “low juice” concentrate may be diluted with additional water to provide, for example, “low juice” content fruit drinks, smoothie type juice products, fruit flavored slush drinks, etc. But the components in the emulsified cloud, such as the oil phase ingredients, cloud emulsifier, flavorants, etc., may interact with other components in these highly calcium fortified, higher acid “low juice” concentrates, such as edible gum stabilizers (e.g., xanthan gum), used to stabilize the concentrate against precipitation of calcium salts, etc., and thus may cause these highly calcium fortified, higher acid “low juice” concentrates to destabilize and stratify or separate, including causing phase separation of the emulsified cloud.

Embodiments of the “low juice” edible concentrates of the present invention overcome these potential stability issues that may be caused by using emulsified clouds in highly calcium fortified, higher acid “low juice” edible concentrates (e.g., beverage concentrates) by incorporating an emulsified cloud stabilizer system comprising a combination of pectin and propylene glycol alginate (PGA) to stabilize the emulsified cloud component. These edible concentrates may be prepared with this pectin/PGA stabilizer system without compromising taste, acceptability, drinkability, etc., of the reconstituted product. For example, embodiments of the “low juice” edible concentrates (e.g., beverage concentrates) of the present invention incorporating this pectin/PGA stabilizer system may have a higher acidity to permit significant fortification with highly solubilized calcium, yet provide an improved overall taste impression and drinkability when reconstituted with water or its equivalent to provide single-strength products.

Embodiments of the “low juice” edible concentrates according to the present invention may comprise substantial levels of solubilized calcium (i.e., at least about 0.2% by weight of the concentrate of solubilized calcium, for example, from about 0.2 to about 0.65% by weight of the concentrate, such as from about 0.35 to about 0.65% by weight of the concentrate of solubilized calcium). These edible concentrates also comprise an opacifying amount of the emulsified cloud, for example, at least about 1%, such as at least about 2.5% (e.g., from about 2.5 to about 6% emulsified cloud, by weight of the concentrate to simulate the desired opacity of the juice components (e.g., pulp, pomace, etc.) being replaced by reducing or lowering the juice level, as well as other properties (e.g., mouthfeel). The resulting edible concentrates are high acid (pH of about 4.2 or less, for example, a pH of from about 3.0 to about 3.8) and stable against high temperature processing and storage conditions. For example, embodiments of these edible concentrates may exhibit significant stability against separation or precipitation of components for upwards of at least about 30 days (e.g., upwards of at least about 90 days) at about 21° C. or less.

The emulsified cloud component may comprise a cloud emulsifier and an oil phase in a weight ratio of at least about 0.1:1 cloud emulsifier:oil phase. For example, the weight ratio of the cloud emulsifier and the oil phase present in the emulsified cloud may be in the range of from about 0.1:1 to about 3:1, such as from about 0.5:1 to about 2:1 (e.g., from about 1:1 to about 1.5:1). In general, as the weight ratio of cloud emulsifier and the oil phase within the emulsified cloud increases within the range of from about 0.1:1 to about 3:1, the stability of the emulsified cloud increases.

The mean particle size of the oil droplets present in the emulsified cloud may be in ranges of from about 0.1 to about 0.3 microns, for example, from about 0.15 to about 0.25 microns, such as from about 0.18 to about 0.22 microns. The particle size distribution of the oil droplets in the emulsified cloud may be such that less than about 3%, for example, less than about 1%, such as less than 0.2% (volume percent basis) of the particles have a particle size greater than about 0.39 microns and less than about 9%, for example, less than about 3%, such as less than about 1% of the particles have a particle size of greater than about 0.34 microns (volume percent basis). These parameters for the mean particle size and the particle size distribution of the oil droplets within the emulsified cloud may be required to obtain a stable unweighted emulsion in a flavored beverage. Unweighted emulsified clouds in which the mean particle size of the oil droplets is greater than about 0.3 microns may not necessarily be stable, while unweighted emulsified clouds in which the mean particle size of the oil droplets is less than about 0.1 microns may not necessarily have sufficient opacity, in the beverage products herein. Furthermore, unweighted emulsified clouds in which more than about 3% of the oil droplets are larger than about 0.39 microns, and/or in which more than about 9% of the oil droplets are larger than about 0.34 microns, may not necessarily be stable in the beverage products herein, and may result in beverage products which exhibit creaming or ringing.

Oil-in-water emulsified clouds of the type described herein, wherein the oil droplets have the mean particle size and particle size distribution hereinbefore described, may be prepared by any known method, such as, for example, subjecting the emulsion to high temperature and/or high pressure and/or multiple pass high shear mixing, such as homogenization. A two-stage homogenizer, such as the Gaulin M3 (APV-Gaulin Co., Everett, Mass.) equipped with either the standard or cell disruption valve and with the second stage comprising about 10% of the total pressure, may be useful herein. In a two-stage homogenizer, the second stage provides controlled back pressure may ensure maximum efficiency in the first stage, and at the same time may minimize the possibility of clumping and coalescence of the oil droplets in the emulsion. The pressure setting for the first stage homogenization may be at least about 2500, for example, from about 3000 to about 9000 psig, such as from about 4000 to about 7000 psig. The emulsified cloud may be homogenized from about 2 to about 5 times (number of passes through the homogenizer), such as about 3 times. The temperature of the emulsified cloud may be in the range of from about room temperature to about 190° F. (88° C.), for example, form about 100° F. (38° C.) to about 150° F. (66° C.). In general, as the temperature of the emulsified cloud and the pressure at which the homogenizer is operated increases, the number of passes necessary to obtain the requisite particle size for the oil droplets within the emulsified cloud decreases.

Embodiments of “low juice” high acid edible concentrates containing high levels of calcium fortification may be used to provide a variety of desirable reconstituted edible products (e.g., beverage products), for example, smoothie type products, slush drinks, fruit-juice drinks, etc., with, for example, milk equivalent levels or more of calcium. These concentrates and resulting reconstituted products may be further fortified with other micronutrients, e.g., vitamins C and D, dietary fiber, trace minerals, etc. Embodiments of shelf-stable liquid concentrates for dietary supplements may also be prepared, or may be provided as undiluted, ready-to-drink liquid concentrate supplement products (e.g., a concentrated energy drink, etc.). Embodiments of these calcium-fortified edible beverage concentrates may also be used as an ingredient base for preparing ready-to-drink juice products at bottling/packing plants.

Embodiments of calcium-fortified “low juice” beverage concentrates may be used for reconstitution with water or its equivalent to provide finished single-strength “low juice” beverage products. These beverage concentrates may be formulated at concentrations upwards of about 5-fold, and therefore, by their very nature, these concentrates may be prepared with very minimal water contents (e.g., about 20% or less by weight of the concentrate). For example, these beverage concentrates may comprise fruit juice, along with other sources of sugar, to provide a Degree Brix in the range of from about 10 to about 80° Bx (e.g., from about 30 to about 70° Bx). This very minimal water content may make formulation and fortification with calcium of these concentrates very challenging, especially in the presence of a highly acidic environment and an emulsified cloud. But the inclusion of the emulsified cloud stabilizer system comprising the combination of pectin and PGA offers superior stability for the emulsified cloud in such “low juice” concentrates, therefore improving the quality and shelf-life of such “low juice” concentrates.

Embodiments of the “low juice” edible concentrates using the emulsified cloud stabilizer system comprising the combination of pectin and PGA have been found to stabilize these high acid emulsified cloud-containing concentrates, even in the presence of these fairly high levels of solubilized calcium. In these edible concentrates, the emulsified cloud stabilizer system may comprise pectin in an amount of at least about 0.01% by weight of the concentrate, in combination with PGA in an amount of at least about 0.03% by weight of the concentrate. For example, the emulsified cloud stabilizer component may comprise a combination of pectin (e.g., high methoxy pectin having a degree of methoxylation of greater than about 50%) in an amount of from about 0.01 to about 0.25% (e.g., from about 0.05 to about 0.15%) by weight of the concentrate and PGA in an amount from about 0.03 to about 0.3% (e.g., from about 0.1 to about 0.2%) by weight of the concentrate. The amounts of pectin and PGA used in such emulsified cloud stabilizer systems may be adjusted depending upon the amount of calcium and emulsified cloud present in the concentrate composition to impart the desired finished product characteristics, i.e., based on how much calcium and emulsified cloud is expected to be present per serving. The emulsified cloud stabilizer system may also be formulated (including incorporating other food grade stabilizers) to adjust the viscosity of the edible product prepared from the concentrate, for example, to lower (or raise) the viscosities of beverage products prepared from beverage concentrates.

Embodiments of these “low juice” edible concentrates comprise a highly solubilized meta-stable complex of calcium citrate malate to achieve these significant levels of calcium fortification. Regarding this complex of calcium citrate malate, the relative molar ratio of calcium to citric acid to malic acid in embodiments of these edible concentrates may be varied to achieve, for example, the acidity and pH desired in the reconstituted single-strength edible product. The relative molar ratio of calcium:citric acid:malic acid in embodiments of these edible concentrates may be varied in the range of from about 5.0 to about 16.3 calcium to from about 1.7 to about 8.8 citric acid to from about 2.6 to about 22.2 malic acid. For example, a relative molar ratio of about 7:2:9.5 calcium:citric acid:malic acid may be used in some embodiments of such edible concentrates.

This highly solubilized meta-stable complex of calcium citrate malate may be prepared for embodiments of the “low juice” edible concentrates of the present invention by the addition of, for example, calcium carbonate, calcium oxide, calcium hydroxide, etc., to an aqueous solution of acids which includes citric and malic acid in a molar ratio of calcium to citric acid to malic acid as describe above. After the solubilized complex calcium citrate malate is prepared, this mixture may be added to, for example, fruit juice and other formulation ingredients; for example, sweeteners, flavors, etc., to further stabilize the calcium citrate malate complex, to maintain appropriate acidity, etc., in these edible concentrates. In some embodiments, other edible acids such as phosphoric acid, gluconic acid, etc., may also be included in these concentrates (e.g., in order to further reduce the pH without imparting a sour taste). In other embodiments, the acids present in these concentrates may consist essentially of a mixture of citric and malic acids. The weight ratio of citric acid to malic acid in this mixture may be in the range of from about 1:1 to about 1:4 (e.g., from about 1:1 to about 1:3.3).

Embodiments of the “low juice” edible concentrates of the present invention may be used to provide a variety of calcium-fortified ready-to-eat (R-T-E) food and ready-to-drink (R-T-D) beverage products, as well as calcium-fortified supplement products, including but not limited to, spoonable puddings, gelatins, cultured fruit and dairy products, meal replacement beverages, liquid supplements, frozen treats, etc., which may have a pH of about 4.2 or less, and in the range of, for example, from about 3.0 to about 3.8 and which are fortified with significant levels of solubilized calcium of at least about 0.12% by weight of the single-strength product. Embodiments of the “low juice” edible concentrates of the present invention may also be used to prepare various viscous liquid food and supplement products including food condiments (e.g., spreads, sauces, jams, jelly, ketchup, or sweetener), beverages (e.g., expresso, shakes, ice-cream based drinks), dips, dressings, frozen desserts (e.g., ice cream, frozen fruit bars, frozen yogurt), pudding, dairy or soy-based smoothies, yogurt or yogurt-based drinks, frozen yogurt, soups, etc.

Embodiments of the “low juice” edible concentrates of the present invention used to prepare these edible products may include any concentrate form comprising the essential ingredients described herein, and which is safe and effective for oral ingestion. Embodiments of the edible concentrates of the present invention used to prepare edible products may be formulated to include only the essential ingredients described herein, or may be modified with optional ingredients to form a number of different concentrate forms. Embodiments of the edible concentrates of the present invention used to prepare edible products may be formulated as dietary concentrate forms, which are defined herein as those embodiments comprising the essential ingredients of the present invention in a concentrate form that then contains fat, and carbohydrate, and may also contain other vitamins, minerals, etc., or combinations thereof.

Embodiments of the “low juice” edible concentrates of the present invention may desirably contain other minerals, as well as vitamins, in addition to calcium. For example, these edible concentrates may be formulated to provide edible products comprising at least about 10% of the RDA (e.g., from about 10 to 100% of the RDA) of vitamin D, and at least about 10% of the RDA (e.g., from about 10 to about 50% of the RDA) of one or more other trace minerals which may include iron, zinc, potassium, magnesium, manganese, and copper which may be important nutrients for bone growth and age-related bone health. In addition to the significant levels of calcium, vitamin D and other trace minerals, other optional ingredients which may be present in, for example, fruit juice-based products, for example, fruit juice(s), other beneficial vitamins such as vitamin A, vitamin C (e.g., ascorbic acid which may also function as an antioxidant), vitamin E, vitamin K, thiamine, riboflavin, pyridoxine, vitamins B₁, B₂, B₁₂, etc., carotenoids (e.g., β-carotene, zeaxanthin, lutein, lycopene), niacin, folic acid, pantothenic acid, biotin, choline, inositol, salts/conjugates and derivatives thereof, and combinations thereof, other minerals, non-limiting examples of which may include phosphorus, sodium, molybdenum, chromium (e.g., from chromium picolinate), chloride, etc., and combinations thereof, as well as other nutrient fortification, for example dietary fiber, etc. For example, various dietary fiber sources may be included in the products prepared from embodiments of the edible concentrates of the present invention. These dietary fiber sources may be both soluble and insoluble types, and may be derived from such materials as oat fiber, soy fiber, soy polysaccharides, hydrolyzed fibers, cellulose, hemicellulose, hydrocolloids, methylcellulose, carboxymethyl cellulose, fructooligosaccharides, etc. Those skilled in the art will appreciate that minimum requirements may have been established for these other vitamins and minerals that are known to be necessary for normal physiological function. Those skilled in the art will also understand that appropriate additional amounts of these other vitamins and mineral ingredients may be needed to provide to food products to compensate for some loss during processing and storage of such concentrates. Additionally, those skilled in the art understand that certain micronutrients may have potential benefit for people with diabetes such as chromium, carnitine, taurine, vitamin E, etc., and that higher dietary requirements may exist for certain micro nutrients such as, for example, ascorbic acid due to higher turnover in people with diabetes, etc.

An example of a vitamin and mineral system for embodiments of the “low juice” edible concentrates of the present invention which may be used to prepare a food product used as a meal replacement may comprise, in addition to vitamin D, at least about 10% of the Recommended Daily Intake (RDI) for the vitamins A, C, E, K, β-carotene, biotin, folic acid, pantothenic acid, niacin, choline, etc.; in addition to calcium and the one or more trace minerals, other minerals, including sodium, phosphorous, chloride, iodine chromium, molybdenum, selenium, etc.; the conditionally essential nutrients m-inositol, carnitine, taurine, etc., in a single serving of from about 50 Kcal to about 1000 Kcal.

Artificial sweeteners may also be added to embodiments of the “low juice” edible concentrates of the present invention used to prepare the food or supplement product to enhance the organoleptic quality of the formula. Examples of suitable artificial sweeteners may include saccharine, aspartame, acesulfame K, sucralose, rebaudioside A (Reb-A), etc. Embodiments of the edible concentrates of the present invention used to prepare food or supplement products may also include a flavoring and/or color to provide the food products with an appealing appearance and an acceptable taste for oral consumption. Examples of useful flavorings typically include, for example, strawberry, peach, butter pecan, chocolate, banana, raspberry, orange, blueberry and vanilla.

Embodiments of the “low juice” edible concentrates of the present invention used to prepare food or supplement products may also comprise fat. Suitable fats or sources thereof may include any that are known for or otherwise safe for use in an oral nutritional products, non limiting examples of which include coconut oil, fractionated coconut oil, soybean oil, corn oil, peanut oil, low erucic acid rapeseed oil (canola oil), olive oil, safflower oil, high oleic safflower oil, MCT oil (medium chain triglycerides), sunflower oil, high oleic sunflower oil, sesame seed oil, palm and palm kernel oils, palm olein, marine oils, cottonseed oils, flaxseed oils, and combinations thereof. Numerous commercial sources for the fats listed above are readily available and known to skilled in the art.

The fat component may comprise in whole or in part polyunsaturated fatty acids, including polyunsaturated fatty acid esters or other natural or synthetic source, including short chain (less than about 6 carbon atoms per chain), medium chain (from about 6 to 18 carbon atoms per chain) and long chain (having at least about 20 carbon atoms per chain) fatty acids having two or more carbon:carbon double bonds, including n-3 (omega-3) and n-6 (omega-6) polyunsaturated fatty acids. Non limiting examples of polyunsaturated fatty acids suitable for use herein include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), linoleic acid (C18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof.

Embodiments of the “low juice” edible concentrates of the present invention used to prepare food or supplement products may also comprise a flavorant, concentrations of which may vary substantially depending upon the selected flavorant and other ingredients, as well as the desired flavor profile or intensity desired. Any flavorant that is known or otherwise suitable for use in food products may be used herein, provided that such flavorant is also compatible with the other selected materials, ingredients, additives, etc.

Such flavorants may be natural or synthetic and can be provided by a single or multiple flavored materials. Flavorants for use in the food products are most typically a combination of many ingredients to provide the desired flavor association. Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, cinnamon, camomile, sassafras, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, carrot, celery, tomato, and combinations thereof. These flavorants may be included as part of the emulsified cloud to provide a flavor emulsion.

Embodiments of the “low juice” edible concentrates of the present invention used to prepare food or supplement products may further comprise other optional components, materials, ingredients, additives, etc., that may modify the physical, chemical, aesthetic or processing characteristics of the food or supplement products. Many such optional components, materials, ingredients, additives, etc., that are known or otherwise suitable for use in other food or supplement products may also be used in embodiments of the edible concentrates of the present invention used to prepare the food or supplement products herein, provided that such optional components, materials, ingredients, additives, etc., are safe for human consumption and are compatible with the essential and other components, materials, ingredients, additives, etc., present in embodiments of the edible concentrates of the present invention used to prepare the food or supplement product. Non-limiting examples of other optional ingredients include preservatives, antioxidants, pharmaceutical actives, colorants, additional flavors, etc.

Embodiments of the “low juice” edible concentrates of the present invention used to prepare food or supplement products may also be substantially free of any optional components, materials, ingredients, additives, etc., described herein. In this context, the term “substantially free” means that the selected product contains less than a functional amount of the optional components, materials, ingredients, additives, etc., including zero percent by weight of such optional components, materials, ingredients, additives, etc.

### EXAMPLES

### Example I

A beverage emulsion cloud component useful for providing calcium-fortified edible concentrates is prepared by acidifying clouding ingredient(s) using a commercial mixer (e.g., Waring Blender). Under continuous high speed blending, 57.1 g of N-Creamer 46 (National Starch, Bridgewater, N.J.) is added to 884.87 g of water. After blending for 2 minutes, 57.1 g of canola oil is slowly added under continuous blending for another 2 minutes. Again, while under continuous blending, 0.74 g of citric acid is slowly added to lower the pH below 3.8, followed by 0.19 g of potassium sorbate. The mixture is blended under high shear for another 1 to 2 minutes. The median particle size of the final acidified cloud premix is less than 0.3 microns. The particle size of the cloud premix may be further reduced by additional processing, such as homogenization.

### Example II

An embodiment of a 1+1 orange flavored beverage concentrate is prepared from the following ingredients:

| Ingredient | % w/w |
|---|---|
| Water | 77.8% |
| Crystalline Fructose | 16% |
| Orange Juice Concentrate (Brix 60) | 1.435% |
| Citric Acid | 0.84% |
| Malic Acid | 0.65% |
| Calcium Hydroxide | 0.48% |
| Pectin | 0.03% |
| PGA | 0.05% |
| Vitamin and Mineral Premix | 1.1% |
| Orange Flavors | 0.55% |
| Emulsified Cloud Premix | 1.0564% |
| FD&C Yellow #5 (color) | 0.004% |
| FD&C Yellow #6 (color) | 0.0006% |

The beverage concentrate is prepared from the above ingredients as follows: A water fraction (about 60% of total water), and fructose, are first blended together in an appropriately sized blend tank. Citric acid, malic acid and the vitamin/mineral premix are then added and mixed until dissolved. A calcium hydroxide slurry is prepared and added to the acid mixture until fully dissolved. The orange juice premix, flavor components, and color are then added to the batch.

The beverage emulsion stabilizer component is prepared in a high shear mixer by loading the remaining water, followed by the appropriate amounts of pectin and PGA. The mixture is blended until homogeneous. With continued blending, the emulsified cloud premix is added, and the mixture sent to a blend tank.

The final blend has a pH of 3.3 to 3.8. The blend is pasteurized at 187±5° F. for 13±3 seconds and conventionally bottled. The 1+1 concentrate prepared, when diluted with an equal volume of water, delivers a single-strength, ready-to-drink beverage containing 0.13% soluble calcium, and 5% juice.

### Example III

A 4+1 orange flavored beverage concentrate embodiment is prepared according to the procedure of Example II, but using the following ingredients:

| Ingredient | % w/w |
|---|---|
| Water | 54.32% |
| High Fructose Corn Syrup-55 | 22.5% |
| Fibersol-2 (Soluble Fiber) | 6.0% |
| Orange Juice Concentrate (60° Bx) | 2.87% |
| Tangerine Juice Concentrate (60° Bx) | 2.87% |
| Emulsified Cloud Premix | 2.641% |
| Erydex (Erythritol) | 1.0% |
| Acesulfame-Potassium | 0.125% |
| Sucralose | 0.03% |
| Beta Carotene | 0.175% |
| Citric Acid | 0.8991% |
| Malic Acid | 2.981% |
| Erythrobic Acid | 0.275% |
| Calcium Hydroxide | 1.2% |
| Pectin | 0.125% |
| PGA | _0.15% |
| Vitamin C, D and Mineral Premix | 0.34% |
| Natural Orange Flavors | 1.5% |

The beverage concentrate is prepared from the above ingredients as follows: A water fraction (about 60% of total water), high fructose corn syrup, artificial sweeteners, fructose, and fiber are first blended together in an appropriately sized blend tank. Citric acid, malic acid and the vitamin/mineral premix are then added and mixed until dissolved. A calcium hydroxide slurry is prepared and added to the acid mixture until fully dissolved. The strawberry and apple juice concentrate, the flavor components, and the color are then added to the batch.

The beverage emulsion stabilizer component is prepared in a high shear mixer by loading the mixer with the remaining water followed with the appropriate amounts of pectin and PGA. The mixture is blended until homogeneous. With continued blending, the emulsified cloud premix is added, and the mixture sent to a blend tank.

The final blend has a pH of from 3.5 to 3.8 and a Degree Brix of about 34-36° Bx. The blend is pasteurized at 187±5° F. for 13±3 seconds and conventionally bottled. The 4+1 concentrate, when diluted at 1 part of the concentrate to 4 parts volume of water, yields a single-strength, ready-to-drink beverage containing 0.13% solubilized calcium, 5% juice, and with a pH of about 3.8 and a Degree Brix of about 6-7° Bx.

All documents, patents, journal articles and other materials cited in the present application are hereby incorporated by reference.

Although the present invention has been fully described in conjunction with several embodiments thereof, it is to be understood that various changes and modifications may be apparent to those skilled in the art. Such changes and modifications are to be understood as included within the scope of the present invention as defined by the appended claims, unless they depart therefrom.

What is claimed is:

1. A composition comprising a calcium-fortified concentrate, the concentrate comprising:
calcium citrate malate in an amount providing a level of solubilized calcium of at least about 0.2% by weight of the concentrate, and a level of total acids sufficient to impart a pH of about 4.2 or less to the concentrate;
an opacifying amount of an emulsified cloud component comprising:
an oil phase; and
a cloud emulsifier in a weight ratio of cloud emulsifier to oil phase of at least about 0.1:1; and
an emulsified cloud stabilizer component to stabilize emulsified cloud component, the emulsified cloud stabilizer component comprising:
pectin in an amount of at least about 0.01% by weight of the concentrate; and
propylene glycol alginate in an amount of at least about 0.03% by weight of the concentrate;
wherein the concentrate comprises from about 10 to about 80% by weight solids, and from about 2 to about 15% juice on a single-strength basis.

2. The composition of claim 1, wherein the concentrate is a beverage concentrate.

3. The composition of claim 2, wherein the beverage concentrate comprises from about 2 to about 5% fruit juice on a single-strength basis.

4. The composition of claim 1, wherein the amount of solubilized calcium is in the range of from about 0.2 to about 0.65% by weight of the concentrate.

5. The composition of claim 4, wherein the amount of solubilized calcium is in the range of from about 0.35 to about 0.65% by weight of the concentrate.

6. The composition of claim 1, wherein the emulsified cloud component is in an amount of at least about 1% by weight of the concentrate.

7. The composition of claim 6, wherein the emulsified cloud component is in an amount of at least about 2.5% by weight of the concentrate.

8. The composition of claim 7, wherein the emulsified cloud component is in an amount of from about 2.5% to about 6% by weight of the concentrate.

9. The composition of claim 1, wherein the emulsified cloud component comprises a modified starch emulsifier.

10. The composition of claim 9, wherein the emulsified cloud component comprises a weight ratio of modified starch emulsifier to oil phase in the range of from about 0.1:1 to about 3:1.

11. The composition of claim 10, wherein the wherein the emulsified cloud component comprises a weight ratio of modified starch emulsifier to oil phase in the range of from about 0.5:1 to about 2:1.

12. The composition of claim 1, wherein the level of total acids is at least about 1.5% by weight of the concentrate.

13. The composition of claim 12, wherein the level of total acids is in the range of from about 1.5 to about 13% by weight of the concentrate.

14. The composition of claim 1, wherein the concentrate has pH is in the range of from about 3.0 to about 3.8.

15. The composition of claim 1, wherein the concentrate comprises one or more trace minerals.

16. The composition of claim 15, wherein the one or more trace minerals comprise iron, zinc, magnesium, manganese, copper, potassium, or mixtures thereof.

17. The composition of claim 1, wherein citric acid and malic acid are present in the concentrate in a weight ratio of citric acid to malic acid in the range of from about 1:1 to about 1:4.

18. The composition of claim 1, wherein the emulsified cloud stabilizer component comprises the pectin in an amount of from about 0.01 to about 0.25% by weight of the concentrate, and the propylene glycol alginate in an amount from about 0.03 to about 0.3% by weight of the concentrate.

19. The composition of claim 18, wherein the emulsified cloud stabilizer component comprises the pectin in an amount of from about 0.05 to about 0.15% by weight of the concentrate, and the propylene glycol alginate in an amount from about 0.1 to about 0.2% by weight of the concentrate.

20. The composition of claim 18, wherein the pectin comprises a high methoxy pectin having a degree of methoxylation of greater than about 50%.

21. The composition of claim 1, having a relative molar ratio of calcium:citric acid:malic acid in a range of from about 5.0 to about 16.3 calcium to from about 1.7 to about 8.8 citric acid to from about:2.6 to about 22.2 malic acid.

22. The composition of claim 21, wherein the relative molar ratio of calcium:citric acid:malic acid is about 7:2:9.5.

23. The composition of claim 1, which provides a single-strength beverage product when reconstituted with from about 1 to about 5 parts by volume of water.

24. The composition of claim 23, which provides a single-strength beverage product when reconstituted with from about 3 to about 5 parts by volume of water.

25. The composition of claim 24, which provides a single-strength beverage product when reconstituted with from about 4 to about 5 parts by volume of water.

26. The composition of claim 1, which comprises a ready-to-drink liquid concentrate supplement product.

27. The composition of claim 1, wherein the emulsified cloud component comprises oil phase droplet particles having a median particle size of from about 0.1 to about 0.3 microns.

28. The composition of claim 27, wherein the emulsified cloud component comprises oil phase droplet particles having a median particle size of from about 0.15 to about 0.25 microns.

29. A method comprising the following steps:
(a) mixing an emulsified cloud component and an emulsified cloud stabilizer component under high shear conditions to provide a stabilized emulsified cloud component; and
(b) combining the stabilized emulsified cloud component with other concentrate ingredients comprising calcium citrate malate to provide an edible calcium-fortified concentrate, wherein the calcium citrate malate is in an amount sufficient to provide a level of solubilized calcium of at least about 0.2% by weight of the concentrate, a level of total acids sufficient to impart a pH of about 4.2 or less to the concentrate, wherein the concentrate comprises from about 10 to about 80% by weight solids, and from about 5 to about 15% juice on a single-strength basis; wherein the emulsified cloud component is in an opacifying amount and comprises:
an oil phase; and
a cloud emulsifier in a weight ratio of cloud emulsifier to oil phase of at least about 0.1:1; and
wherein the emulsified cloud stabilizer component comprises:
pectin in an amount of at least about 0.01% by weight of the concentrate; and
propylene glycol alginate in an amount of at least about 0.03% by weight of the concentrate.

30. The method of claim 29, wherein the stabilized emulsified cloud component of step (a) is formed by homogenizing the emulsified cloud component and the emulsified cloud stabilizer component.

31. The method of claim 29, wherein the stabilized emulsified cloud component of step (a) comprises oil phase droplet particles having a median particle size of from about 0.1 to about 0.3 microns.

32. The method of claim 31, wherein the stabilized emulsified cloud component of step (a) comprises oil phase droplet particles having a mean particle size in the range of from about 0.15 to about 0.25 microns.
